(19) United States
(12) Patent Application Publication
(10) Pub. No.: US 2022/0138712 A1
(43) Pub. Date: May 5, 2022

(54) Methods and Systems For Rendering Early Access To Paychecks

(71) Applicant: Huntington Bancshares Incorporated, Columbus, OH (US)

(72) Inventors: Bryan James Carson, New Albany, OH (US); Mark Richard Rhoades, Columbus, OH (US); James Steven Richards, II, Columbus, OH (US)

(21) Appl. No.: 17/188,733

(22) Filed: Mar. 1, 2021

Related U.S. Application Data
(60) Provisional application No. 63/110,171, filed on Nov. 5, 2020.

(51) Int. Cl. G06Q 20/10; G06Q 20/04; G06Q 20/40; G06F 17/18

(52) U.S. Cl. CPC G06Q 20/108; G06F 17/18; G06Q 20/405; G06Q 20/0425

(57) ABSTRACT

A method performed by a server executing an algorithm to render early access to a paycheck to a customer through funds advance. The method including the steps of determining customer's eligibility in a financial institution for early access to paycheck and an approved amount (or a percentage) of the at least one paycheck based on decisioning criteria and customer's recurring direct deposit transactions data. The decisioning criteria may evaluate a reoccurrence and a deposit amount of at least one direct deposit, a direct deposit periodicity and an average monthly or daily account balance. The direct deposit transactions data may include mining transaction description such as text information on the at least one direct deposit to verify authenticity of the customer's data on the at least one direct deposit.

### CROSS-REFERENCE

The present application claims the benefit of priority under 35 U.S.C. § 119 from U.S. Provisional Patent Application Ser. No. 63/110,171 entitled “METHODS AND SYSTEMS FOR RENDERING EARLY ACCESS TO PAYCHECKS,” filed on Nov. 5, 2020, the disclosure of which is hereby incorporated by reference in its entirety for all purposes.

### TECHNICAL FIELD

The present disclosure generally relates to financial management systems and loan products and services, and more specifically relates to methods and systems for rendering early access to paycheck(s).

### BACKGROUND

Some customers who may face financial hardship and devastation may need early access to their paycheck(s) for financial relief and help from, for example, their financial institutions. Such relief, however, may not be available from their financial institutions or may otherwise come at a steep cost that further reduces a net amount of the paycheck(s) that they may receive.

### BRIEF DESCRIPTION OF DRAWINGS

The disclosure is better understood with reference to the following drawings and description. The elements in the figures are not necessarily to scale, emphasis are instead being placed upon illustrating the principles of the disclosure. Moreover, in the figures, like-referenced numerals may designate to corresponding parts throughout the different views.

FIG. 1 illustrates an example of a computer implemented method of rendering an early access to a paycheck to an eligible user.

FIG. 2 illustrates a screenshot of an exemplary mobile application which renders an early access to a paycheck to an eligible user.

FIG. 3 illustrates an exemplary enrollment process for rendering an early access (EA) to paycheck product to an eligible user.

FIG. 4 illustrates an exemplary data communication system diagram for rendering an early access to paycheck product to an eligible user.

### SUMMARY

A financial product, such as, an Early Access to Paycheck(s) (EAP) program, may provide financial hardship relief to some customers of a financial institution for up to two days in advance or other advance time period. More specifically, this financial product may be offered to customers of the financial institution based on a banking relationship and a direct deposit periodicity pattern, that may meet a long felt need of banking customers. The EAP program enables customers early access of an approved amount (or an approved percentage) of an entire paycheck based on decisioning criteria that analyzes a customer's checking relationship versus their direct deposit transactions.

In an example, the disclosure describes a computer implemented method of rendering early access to a paycheck of a customer. The method may be performed by at least a processor in a server and at least one code stored in a non-transitory computer-readable medium which causes the server to perform steps, including at least: determining a customer's eligibility for an early access to a paycheck(s) by evaluating in a database about the customer's bank relationship with a financial institution and direct deposit transactions data. A decisioning criteria for approving the early access of an approved amount or a specified percentage to at least one paycheck up to an approved number of days in advance. The decisioning criteria may include evaluating a deposit amount of at least one direct deposit, direct deposit periodicity of the at least one direct deposit and text mining of transaction description of the at least one direct deposit. A user's device of a qualifying customer may have a mobile banking application linking to the at least one opened checking account with recurring deposits made at the financial institution to qualify for the early access to the at least one paycheck, and the mobile banking application may be enabled to access the approved amount or the specified percentage of the at least one paycheck in a form of an early funds advance to be deposited into the at least one opened checking account, without a service charge and without interests charged by the financial institution.

Likewise, the disclosure describes a non-transitory computer-readable medium which stores at least one code, when executed by at least a processor in a computer, causes the computer to render early access to a paycheck to a customer by performing the steps using the same method as mentioned above.

According to certain aspects, the disclosure describes a computer implemented method of rendering early access to paycheck of a customer. The method may be performed by at least a processor in a server and at least one code stored in a non-transitory computer-readable medium which causes the server to perform the step of determining the customer's eligibility for an early access to paycheck by evaluating in a database about the customer: a reoccurrence of at least one direct deposit to at least one opened direct deposit account at a financial institution, and transaction description text mining of the at least one direct deposit as decisioning criteria for approving the early access of an approved amount or a specified percentage of at least one paycheck up to an approved number of days in advance. The computer implemented method also includes processing enrollment of the customer for the early access to paycheck based on determining that the at least one direct deposit to the at least one opened direct deposit account reoccurs. The computer implemented method also includes transmitting the approved amount or the specified percentage of the at least one paycheck as early funds advance into the at least one opened deposit account, without a service charge and without interests charged by the financial institution.

In such aspects, the disclosure likewise describes a non-transitory computer-readable medium which stores at least one code, when executed by at least a processor in a computer, causes the computer to render early access to a paycheck to a customer by performing the steps using the same method as mentioned above.

According to other aspects, the disclosure describes a computer implemented method of rendering early access to paycheck of a customer. The method may be performed by at least a processor in a server and at least one code stored in a non-transitory computer-readable medium which causes the server to perform the step of determining, eligibility of a customer for an early access to at least one direct deposit paycheck by evaluating in a database: bank relationship with a financial institution, a reoccurrence of at least one direct deposit to at least one opened deposit account at a financial institution, a pay periodicity of the at least one direct deposit and transaction description text mining of the at least one direct deposit as decisioning criteria for approving the early access of an approved amount or a specified percentage to the at least one direct deposit up to an approved number of days in advance. The computer implemented method also includes processing enrollment to the early access to the at least one direct deposit paycheck based on determining the eligibility of the customer qualifies for the early access to the at least one direct deposit paycheck. The computer implemented method also includes generating instructions to enable the early access of the approved amount or the specified percentage of the at least one direct deposit paycheck as early funds advance to be deposited into the at least one opened deposit account, without a service charge and without interests charged by the financial institution.

### DETAILED DESCRIPTION

Where it is appropriate throughout the description, the term “paycheck”, “paycheck(s)”, or “recurring payroll” may be used interchangeably, the term “user” and “customer” may be used interchangeably, and the term “computer” and “server” may be used interchangeably without limitation.

In one or more implementations, not all of the depicted components in each figure may be required, and one or more implementations may include additional components not shown in a figure. Variations in the arrangement and type of the components may be made without departing from the scope of the subject disclosure. Additional steps, components, different components, or fewer components may be utilized within the scope of the subject disclosure.

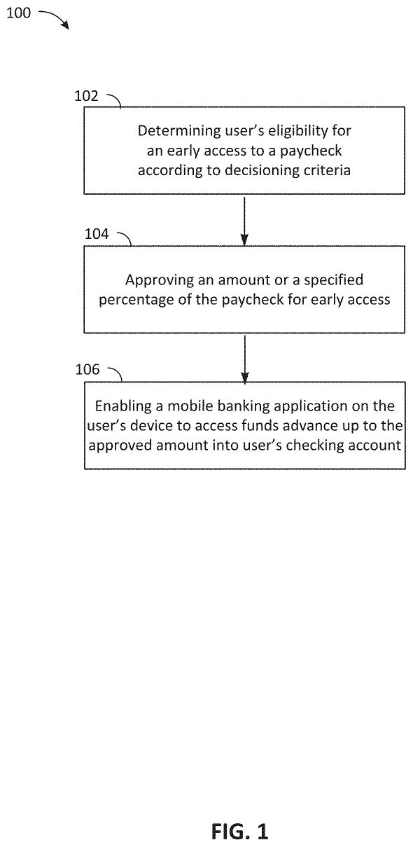

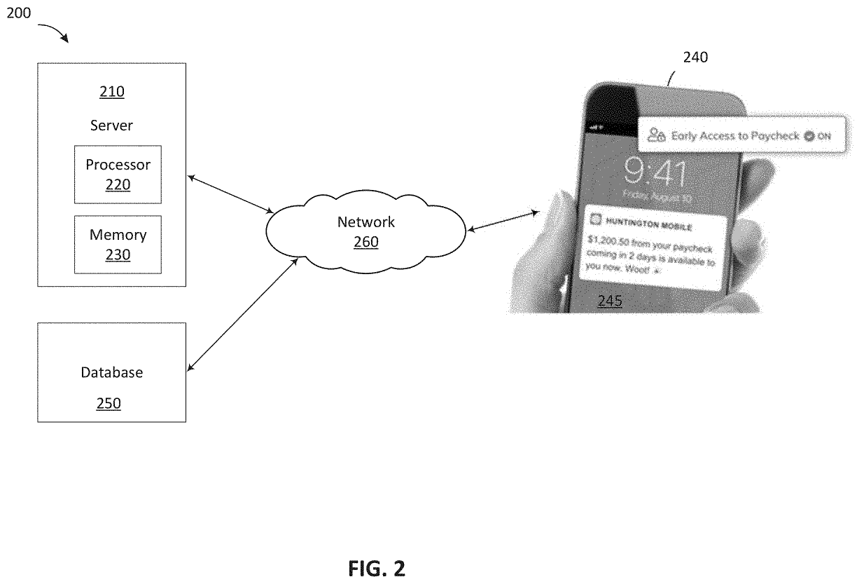

FIG. 1 illustrates an example of a computer implemented method 100 of rendering an early access to a paycheck to an eligible user. In an embodiment, the method may be performed by a server (such as server 210 in FIG. 2) or by distributed processing in a cluster of computers (e.g., cloud computing). In implementation, the server 210 may include at least a processor 220 and a memory 230 (non-transitory computer-readable medium) which stores program code (algorithm). When being executed by the processor 220, the program code may cause the server 210 to perform steps in FIG. 1, which renders early access to at least one paycheck to a user in a form of a funds advance and, in certain aspects, enables a mobile banking application 245 installed on a user device 240 to access the funds advance.

In step 102, the server 210 may communicate with a database 250 through a network 260 to access user's bank relationship data with a financial institution to determine user's eligibility for early access to the at least one paycheck and a determination of an approved amount (or a percentage) of the paycheck based on decisioning criteria and based on user's recurring direct deposit (e.g., payroll) transactions data of at least one opened deposit account such as, but not limited to, checking, savings, money-moving, or other deposit accounts.

At a minimum, the decisioning criteria requires that the user has at least one opened direct deposit account such as, for example, checking, savings, money-moving, or other deposit accounts with recurring deposits made at the financial institution in order to qualify for the early access to the at least one paycheck. The decisioning criteria may evaluate, for example, a recurring deposit amount of the at least one paycheck, a pay periodicity (i.e., weekly, biweekly, semi-monthly, monthly, etc.) of the at least one paycheck, and an average monthly or daily account balance. The recurring direct deposit transactions data may include text mining transaction description such as mining text information on the at least one direct deposit to verify authenticity of the recurring deposits (e.g., payroll) and recipient's data on the at least one opened direct deposit account. Other decisioning criteria for eligibility may also include overdraft history or frequency (if any) over a plurality of financial statement cycles.

Although eligibility may be determined by the customer's at least one opened direct deposit account (e.g., checking account) and relationship activity, eligibility are transparent to the customer in product disclosures including the moment when a customer is no longer eligible (i.e., job termination, fraud, unemployment, etc.), the product may reduce the approved amount of early access to a paycheck, or altogether remove as an option from online and mobile banking.

In certain embodiments, customers may be auto-enrolled into the early access paycheck (EAP) program. Alternatively, it may be that customers select to opt into the EAP program, including through a mobile bank application 245 or other form of online banking. In one or more embodiments, the approved amount may be the full amount of the paycheck being deposited in advance with no calculation being performed of an approved amount.

In certain embodiments, customers may use online banking tools to access the advanced funds but enrollment or usage of online banking tools may not be required in order for customers to be eligible for and enrolled in the EAP program.

In step 104, when it is determined that the user is eligible for early access to the paycheck, an approved amount or a specified percentage of the entire paycheck may be available to the user for funds advance. In certain aspects, as depicted in step 106, a mobile banking application 245 installed on the user's device 240 may be enabled to access the approved amount or the specified percentage of the entire paycheck through funds advance transfer into the user's at least one opened direct deposit account. In an embodiment, a full amount (100%) or an approved amount (or an approved percentage <100%) of money may be immediately transferrable into the customer's at least one opened direct deposit account, including, in certain aspects, access through the mobile bank application 245 or other form of online banking, while any balance of the remainder of the actual payroll/pension may be deposited into customers' at least one opened direct deposit account. In certain aspects, an alert message may be sent to the user's device up to an approved number of days (e.g., two days before payday) in advance, to notify the user of an availability to transfer up to the approved amount or the specified percentage of the at least one paycheck as early funds advance into the at least one opened direct deposit account. When the amount is deposited in advance, customers may receive notifications of the deposit in a form of emails/text/push notifications. In an embodiment, the financial institution may not charge a service charge or levy any interests on the funds advance from the early access to the paycheck.

In certain embodiments, a direct deposit paycheck periodicity may be determined by text mining and an analysis of at least one verified direct deposit paycheck transaction description and recording the direct deposit paycheck periodicity (i.e., weekly, biweekly, bimonthly or monthly) to enable the financial institutions to determine eligibility and/or a maximum approved amount (or approved percentage) of the payroll/pension transactions up to two days in advance or other advance time period. In certain implementations, the transaction description text mining of the at least one direct deposit includes: text mining of standard accounting words or accounting processing code on the at least one direct deposit.

An example of a method of text mining to determine a legitimate recurring direct deposit paycheck may be performed through: text mining transaction descriptions to allow the financial institution to identify keyword tokens associated with customer paycheck or pension payments, that is, text mining transaction descriptions such as “PAYROLL” may be identified as SALARY, REG.SALARY, or PAYROLL, etc. In some embodiments, some common language may seem ambiguous in text mining analysis such as “PAY” or “DIRDEP” which may also mean payroll, but text mining may also include other kinds of non-universal terminology payment codes such as Standard Entry Codes from ACH (Automated Clearing House) batch records that matches “CCD” (Cash Concentration and Disbursement) and “IAT” (International ACH Transaction), etc.

In certain implementations, the pay periodicity may be determined by calculating a mean difference between deposit dates (or pay dates), using the mean difference between the deposit dates to separate transactions into weekly, biweekly and monthly groups; and using a standard deviation of the mean difference between the deposit dates to exclude irregular transactions. The excluded irregular transactions may include transactions with a coefficient of variation greater than 0.5, where non-payroll/pension transactions may be identified as regular transactions. In certain cases, if the at least one direct deposit paycheck fails to clear in the at least one opened deposit account, the financial institution may recover an entire amount or at least a portion of the early funds advance from the at least one opened deposit account in a same or subsequent statement period.

FIG. 2 illustrates an example of a screenshot of a mobile application 245 which is installed in a user's device 240 for rendering early access to a paycheck in the form of a direct deposit. More specifically, the rendering may be performed by a processor 220 in a computer (such as server 210) executing program code stored in a non-transitory computer-readable medium (e.g., memory 230), which causes the computer to render early access to the direct deposit to the user's device 240 by performing steps already described in FIG. 1. In an embodiment, the financial institution may proactively offer early access of the full direct deposit paycheck, and/or an approved amount up to a full amount of or up to 100% of the direct deposit paycheck two days in advance, but no more than a defined maximum amount. In certain embodiments, the approved amount may be a portion of an entire direct deposit paycheck, for example, $500 per every $1,000 up to $2,000, two days in advance of the direct deposit paycheck. The early access to paycheck are featured with zero percent (0%) Advance Fee and 0% APR interest to its customers. However, in certain aspects, the financial institution may elect to charge customers for advances by providing customers with notice of charges and fees as applicable. Eligible customers may be required to have at least one opened deposit account with recurring deposits for at least a defined period of time (e.g., three months recurring deposits with the financial institution) and prove that employment with the same employer meets a minimum qualified period (e.g., at least six months with the same employer). As shown in FIG. 2, the mobile bank application 245 may display a notification message sent by the computer (server 210) that states “$1,200.50 from your paycheck coming in 2 days is available to you now. Woot!”.

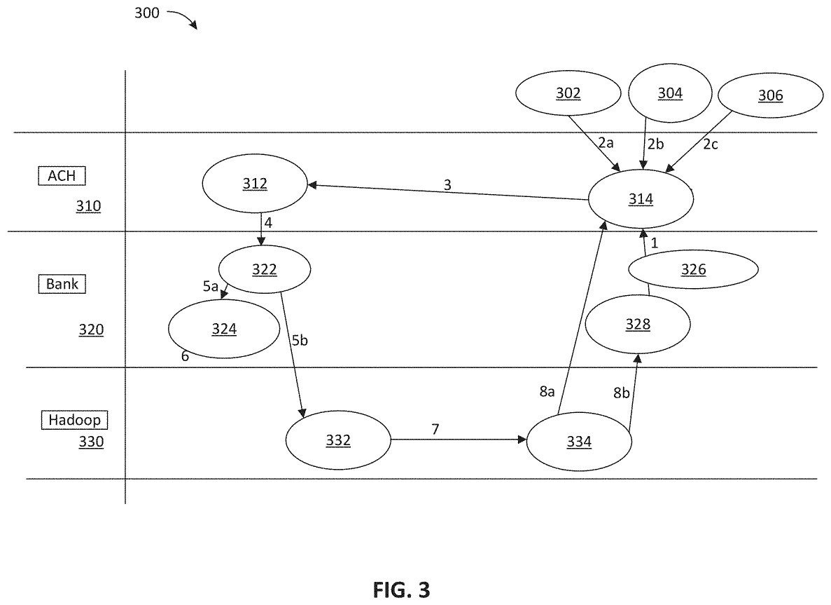

FIG. 3 illustrates an exemplary enrollment process 300 for rendering an early access (EA) to a paycheck product to an eligible user. In an embodiment, the enrollment process 300 may include interactions among a bank 320 (e.g., a financial institution), an ACH 310 (Automated Clearing House) and a Hadoop cluster 330 (e.g., networked computing nodes or cloud). In implementation, the bank 320 may perform step 1, a daily determination of eligible accounts 328 and updating of eligible early access account list 326. The ACH 310 may receive updated eligible EA account list 326 from the bank 310 to process payroll (see steps 2a-2c) from employees 302, 304 and 306, respectively, and create an ACH posting file (see steps 3-4) based on the results from the determining transactions for early access 314. The ACH 310 may send the ACH posting file 322 to the bank 320 in order to send (see steps 5a, 5b and 6) the ACH daily posting files 324 and then store (see step 7) the ACH daily posting file in a Hadoop database 332 which Hadoop 330 may perform data analysis 334 to enable early access of direct deposit paychecks (see step 8a) to eligible customers according to the stored ACH daily posting file and update the eligible customers by the bank 320 (see step 8b).

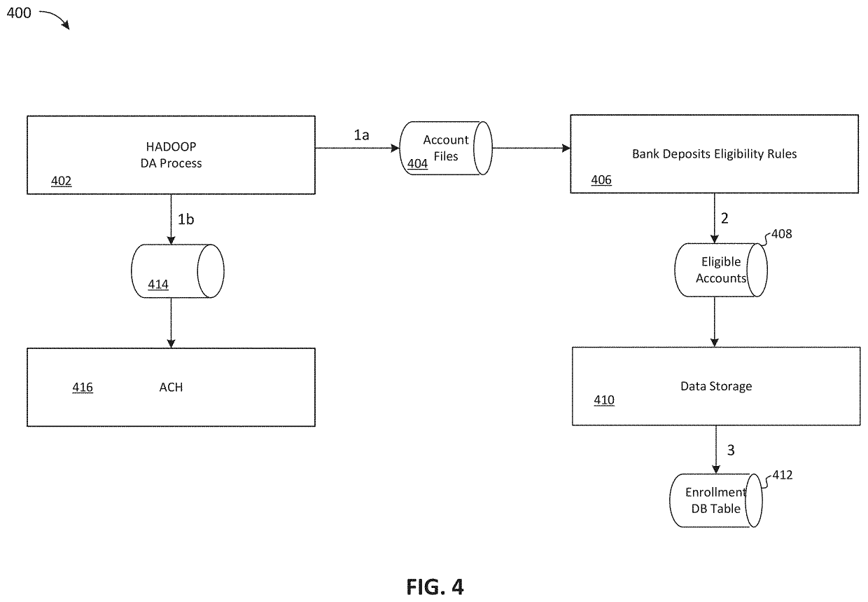

FIG. 4 illustrates an exemplary data communication system 400 for rendering an early access to paycheck product to an eligible user. In an embodiment, the system may include a server 402 which may be a cluster of networked computers such as Hadoop to perform data analysis (DA) (see operations 1a, 1b) from a database to analyze a customer's account file 404 for determination of eligibility based on decisioning criteria in a financial institution's mainframe 406 which may include recurring bank deposits history, or to process an eligible customer account file 414 (e.g., deposit file) for early access paycheck ACH processing system 416.

In certain implementations, for example, on a weekly basis, two customer's account files (404, 414) may be FTP'ed (via file transfer protocol) to the financial institution's mainframe 406 (e.g., from the server 402 by a DA team 402 in step 1a, and the customer's account file 414 (ID file) may be sent to the ACH processing system 416 in step 1b. In step 2, the customer's account files 404 may be processed based on a decision criteria, such as eligibility rules in the financial institution's mainframe 406. Eligibility rules process the weekly account file sent from the DA team and may flag accounts that are not eligible based on additional eligibility rules. The file 404 may contain all the account eligible for Early Access. If the new customer account file 404 is approved, the account file is flagged as one of the eligible accounts 408 for early access with an approved amount up to an approved number of days, and stored in a database 410 (e.g., DataStage) in an updated enrollment database table 412 (e.g., Enrollment DB2 table) for the early access of paycheck ACH processing system 416.

Various aspects of the claimed subject matter have been described herein and by the appended claims without limiting within the scope of the claimed subject matter.

What is claimed is:

1. A computer implemented method of rendering early access to paycheck of a customer, comprising executing by at least a processor in a server, at least one code stored in a non-transitory computer-readable medium which causes the server to perform steps, comprising:
determining the customer's eligibility for an early access to paycheck by evaluating in a database about the customer: a reoccurrence of at least one direct deposit to at least one opened direct deposit account at a financial institution, and transaction description text mining of the at least one direct deposit as decisioning criteria for approving the early access of an approved amount or a specified percentage of at least one paycheck up to an approved number of days in advance;
processing enrollment of the customer for the early access to paycheck based on determining that the at least one direct deposit to the at least one opened direct deposit account reoccurs; and
transmitting the approved amount or the specified percentage of the at least one paycheck as early funds advance into the at least one opened deposit account, without a service charge and without interests charged by the financial institution.

2. The computer implemented method of claim 1, comprising determining of at least one direct deposit periodicity which comprises:
calculating a mean difference between deposit dates;
using the mean difference between the deposit dates to separate transactions into weekly, biweekly and monthly groups; and
using a standard deviation of the mean difference between the deposit dates to exclude irregular transactions.

3. The computer implemented method of claim 2, wherein the excluded irregular transactions comprises transactions with a coefficient of variation greater than 0.5.

4. The computer implemented method of claim 3, comprises identifying regular transactions that are non-payroll/pension transactions.

5. The computer implemented method of claim 1, wherein the approved amount for the early access includes not exceeding a defined maximum amount up to a full amount to the at least one paycheck.

6. The computer implemented method of claim 1, wherein the approved number of days for the early access to the at least one paycheck with the approved amount is up to two days in advance.

7. The computer implemented method of claim 1, wherein the transaction description text mining of the at least one direct deposit comprises: text mining of standard accounting words or accounting processing code on the at least one direct deposit.

8. The computer implemented method of claim 1, wherein after the customer is determined to be eligible, the early access to the at least one paycheck is approved up to a full amount or 100% of the at least one paycheck for up to the approved number of days in advance.

9. The computer implemented method of claim 1, further comprising sending an alert message to a user device of the customer up to the approved number of days in advance, to notify the customer of an availability to transfer up to the approved amount or the specified percentage of the at least one paycheck as early funds advance into the at least one opened direct deposit account.

10. The computer implemented method of claim 9, further comprising recovering a portion of or up to an entire amount of the early funds advance approved amount or the specified percentage of the at least one paycheck, in case the at least one paycheck fails to clear in the at least one opened direct deposit account.

11. A non-transitory computer-readable medium which stores at least one code, when executed by at least a processor in a computer, causes the computer to render early access to paycheck to a customer by performing steps, comprising:
determining the customer's eligibility for an early access to paycheck by evaluating in a database about the customer: a reoccurrence of at least one direct deposit to at least one opened direct deposit account at a financial institution, and transaction description text mining of the at least one direct deposit as decisioning criteria for approving the early access of an approved amount or a specified percentage of at least one paycheck up to an approved number of days in advance;
processing enrollment of the customer for the early access to paycheck based on determining that the at least one direct deposit to the at least one opened direct deposit account reoccurs; and
transmitting the approved amount or the specified percentage of the at least one paycheck as early funds advance into the at least one opened deposit account, without a service charge and without interests charged by the financial institution.

12. The non-transitory computer-readable medium of claim 11, comprising determining of at least one direct deposit periodicity which comprises:
calculating a mean difference between deposit dates;
using the mean difference between the deposit dates to separate transactions into weekly, biweekly and monthly groups; and
using a standard deviation of the mean difference between the deposit dates to exclude irregular transactions.

13. The non-transitory computer-readable medium of claim 12, wherein the excluded irregular transactions comprises transactions with a coefficient of variation greater than 0.5.

14. The non-transitory computer-readable medium of claim 13, wherein the method comprises identifying regular transactions that are non-payroll/pension transactions.

15. The non-transitory computer-readable medium of claim 11, wherein the approved amount for the early access includes not exceeding a defined maximum amount up to a full amount to the at least one paycheck.

16. The non-transitory computer-readable medium of claim 11, wherein the approved number of days for the early access to the at least one paycheck with the approved amount is up to two days in advance.

17. The non-transitory computer-readable medium of claim 11, wherein the transaction description text mining of the at least one paycheck comprises: text mining of standard accounting words or accounting processing code on the at least one paycheck.

18. The non-transitory computer-readable medium of claim 11, wherein the method comprises after the customer is determined to be eligible, the early access to the at least one paycheck is approved up to a full amount or 100% of the at least one paycheck for up to the approved number of days in advance.

19. The non-transitory computer-readable medium of claim 11, wherein the method further comprises sending an alert message to the user device of the customer up to the approved number of days in advance, to notify the customer of an availability to transfer up to the approved amount or the specified percentage of the at least one paycheck as early funds advance into the at least one opened direct deposit account.

20. A computer implemented method of rendering early access to at least one or more direct deposit paychecks, comprising executing by at least a processor in a server, at least one code stored in a non-transitory computer-readable medium which causes the server to perform steps, comprising:
determining, eligibility of a customer for an early access to at least one direct deposit paycheck by evaluating in a database: bank relationship with a financial institution, a reoccurrence of at least one direct deposit to at least one opened deposit account at a financial institution, a pay periodicity of the at least one direct deposit and transaction description text mining of the at least one direct deposit as decisioning criteria for approving the early access of an approved amount or a specified percentage to the at least one direct deposit up to an approved number of days in advance;
processing enrollment to the early access to the at least one direct deposit paycheck based on determining the eligibility of the customer qualifies for the early access to the at least one direct deposit paycheck; and
generating instructions to enable the early access of the approved amount or the specified percentage of the at least one direct deposit paycheck as early funds advance to be deposited into the at least one opened deposit account, without a service charge and without interests charged by the financial institution.
